(19) United States
(12) Patent Application Publication
(10) Pub. No.: US 2026/0122173 A1
(43) Pub. Date: Apr. 30, 2026

(54) Controlling Phone Notifications while Driving a Vehicle Based on Different Driving Contexts

(71) Applicant: Volvo Car Corporation, Göteborg (SE)

(72) Inventors: Axel BOUVIER, Göteborg (SE); Thomas BERNICHON, Göteborg (SE); Mathias Yannick Philippe LE SAUX, Göteborg (SE); Mariam FRENNING, Göteborg (SE)

(21) Appl. No.: 18/913,282

(22) Filed: Oct. 11, 2024

(51) Int. Cl. H04M 1/72454; H04M 1/72409; H04W 4/48

(52) U.S. Cl. CPC H04M 1/72454; H04M 1/724098; H04W 4/48

(57) ABSTRACT

Techniques for controlling phone notifications while driving a vehicle based on different driving contexts are provided. For example, a method comprises monitoring, by a system comprising a processor, data communications received by a communication device connected to an onboard computer system of a vehicle in association with operation of the vehicle. The method further comprises monitoring, by the system, a driving context of the vehicle in association with the operation of the vehicle, and controlling, by the system, rendering via one or more electronic output devices integrated on or within the vehicle, notification data regarding reception of a data communication of the data communications based on whether the driving context satisfies an acceptable criterion conducive for the rendering.

### TECHNICAL FIELD

The disclosed subject matter relates to vehicles (e.g., transportation vehicles), and more particularly, to controlling phone notifications while driving a vehicle based on different driving contexts.

### BACKGROUND

Driving mode on a phone is a feature designed to minimize distractions while driving. When activated, it typically silences notifications, auto-replies to incoming calls and messages indicating that you're currently driving, and may even limit access to certain apps or features that could be distracting. Some driving modes can also be set up to activate automatically when your phone detects that you're in a moving vehicle, using various technologies like global positioning system (GPS) navigation or Bluetooth™ connections to determine motion.

While driving modes on phones are intended to promote safer driving practices, there can be some issues associated with them. In particular, while driving mode is active, it typically suppresses notifications to minimize distractions. However, this can lead to important messages or calls being missed, which could be problematic in urgent situations. In addition, continuous monitoring of motion or location by the phone to determine driving status can consume battery life more quickly, especially if the feature is set to activate automatically.

The above-described background relating to existing driving modes for phones is merely intended to provide a contextual overview of some current issues and is not intended to be exhaustive. Other contextual information may become further apparent upon review of the following detailed description.

### SUMMARY

The following presents a summary to provide a basic understanding of one or more embodiments of the invention. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, systems, devices, computer-implemented methods, apparatuses and/or computer program products that facilitate controlling phone notifications while driving a vehicle based on different driving contexts are described.

As alluded to above, techniques for improving existing driving modes on phones are desirable, and various embodiments are described herein to this end and/or other ends.

According to an embodiment, a system can comprise a memory that stores computer-executable components, and a processor that executes the computer-executable components stored in the memory, including a communication monitoring component, a context component, and a rendering control component. The communication monitoring component monitors data communications received by a communication device (e.g., a phone) connected to an onboard computer system of a vehicle in association with operation of the vehicle. The context component determines and monitors a driving context of the vehicle in association with the operation of the vehicle. The rendering control component further controls rendering, via one or more electronic output devices integrated on or within the vehicle, notification data regarding reception of a data communication of the data communications based on whether the driving context satisfies an acceptable criterion conducive for the rendering.

To this end, the acceptable criterion can define an acceptable driving context when phone notifications can be provided to the driver, such as when the vehicle is stopped at a red light for a reasonable duration of time, parked, diving in an autonomous driving mode or a semi-autonomous driving mode with limited traffic around, and the like. In this regard, in various embodiments, the acceptable criterion relates to at least one of: a driving mode of the vehicle, a minimum duration of time over which the vehicle is expected to remain stopped, an amount of traffic around the vehicle, a speed of the vehicle, or an estimated measure of variation to the speed of the vehicle. In an aspect wherein the acceptable criterion comprises the driving context corresponding to the vehicle being stopped for a minimum duration of time, the context component can predict whether the vehicle will be stopped for the minimum duration of time using artificial intelligence (AI). For instance, the context component can determine or predict whether the vehicle will be stopped for the minimum duration of time based on at least one of, a reason for the vehicle being stopped, a route of the vehicle, a location of the vehicle at which the vehicle is stopped, or a traffic condition associated with a location.

In this regard, the rendering control component can be configured to render the notification data based on a determination that the driving context satisfies the acceptable criterion and prevent the rendering of the notification data based on a determination that the driving context fails to satisfy the acceptable criterion. In some implementations in which the rendering control component prevents the rendering of the notification, the rendering control component can be configured to render the notification data in response to a change in the driving context (e.g., as detected by the context component) resulting in the driving context satisfying the acceptable criterion. In some implementations, the rendering control component can also control the rendering based on an entity from which the data communication is received and/or a priority level associated with the data communication, and wherein the acceptable criterion varies for different data communications corresponding to different entities from which the different data communications are received and/or different priority levels.

In accordance with various embodiments, the system above can correspond to a system of the communication device or the onboard computer system of the vehicle. In other embodiments, the computer-executable components can be distributed between the communication device and the onboard computer system of the vehicle.

According to another embodiment, a method can comprise monitoring, by a system comprising a processor, data communications received by a communication device connected to an onboard computer system of a vehicle in association with operation of the vehicle; monitoring, by the system, a driving context of the vehicle in association with the operation of the vehicle; and controlling, by the system, rendering via one or more electronic output devices integrated on or within the vehicle, notification data regarding reception of a data communication of the data communications based on whether the driving context satisfies an acceptable criterion conducive for the rendering.

According to yet another embodiment, a non-transitory machine-readable medium can comprise executable instructions that, when executed by a processor integrated on or within a vehicle, facilitate performance of operations, comprising, monitoring data communications received by a communication device connected to an onboard computer system of a vehicle in association with operation of the vehicle; monitoring a driving context of the vehicle in association with the operation of the vehicle; and controlling rendering via one or more electronic output devices integrated on or within the vehicle, notification data regarding reception of a data communication of the data communications based on whether the driving context satisfies an acceptable criterion conducive for the rendering.

### BRIEF DESCRIPTION OF DRAWINGS

FIG. 1 illustrates a block diagram of an exemplary system that facilitates controlling phone notifications while driving a vehicle based on different driving contexts, in accordance with one or more embodiments described herein.

FIG. 2 illustrates a block diagram of an example communication device that facilitates controlling phone notifications while driving a vehicle based on different driving contexts, in accordance with one or more embodiments described herein.

FIG. 3 illustrates example computer-executable components that facilitate controlling phone notifications while driving a vehicle based on different driving contexts, in accordance with one or more embodiments described herein.

FIG. 4 illustrates a block flow diagram of an example, non-limiting computer-implemented method for controlling phone notifications while driving a vehicle based on different driving contexts, in accordance with one or more embodiments described herein.

FIG. 5 illustrates a block flow diagram of an example, non-limiting computer-implemented method for controlling phone notifications while driving a vehicle based on different driving contexts, in accordance with one or more embodiments described herein.

FIG. 6 illustrates a block flow diagram of another example, non-limiting computer-implemented method for controlling phone notifications while driving a vehicle based on different driving contexts, in accordance with one or more embodiments described herein.

FIG. 7 illustrates a block flow diagram of another example, non-limiting computer-implemented method for controlling phone notifications while driving a vehicle based on different driving contexts, in accordance with one or more embodiments described herein.

FIG. 8 is an example, non-limiting computing environment in which one or more embodiments described herein can be implemented.

FIG. 9 is an example, non-limiting networking environment in which one or more embodiments described herein can be implemented.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

As alluded to above, techniques for improving existing driving modes for phones are desirable, and various embodiments are described herein to this end and/or other ends. In this regard, a problem with existing driving modes for phones is that all notifications or messages regarding received data communications (e.g., text messages, phone calls, and other types of data communications) are blocked when the driving mode is active. The driving mode is typically automatically activated in response to the phone being located inside the vehicle, being connected to the vehicle onboard computer system and/or otherwise configured to remain activated over the entire course of operation of the vehicle.

In accordance with one or more embodiments, the disclosed solution provides a conditional driving mode that can be executed by the phone and/or an onboard computer system of the vehicle that controls rendering phone notifications via the phone and/or an electronic output device of the vehicle (e.g., an integrated onboard display/speaker of the vehicle) while driving/operating the vehicle based on different driving contexts. In this regard, the different driving contexts can include one or more acceptable driving contexts when phone notifications regarding received data communications can be rendered, such as when the vehicle is stopped at a red light for a reasonable duration of time, parked, diving in an autonomous driving mode or a semi-autonomous driving mode with limited traffic around, and the like. To this end, the phone and/or the onboard computer system of the vehicle can determine when the current context of the vehicle is acceptable for rendering notifications regarding received data communications on the phone and render them only at such times (e.g., during a time when it would not distract the driver). In other words, the phone and/or onboard computer system can render notifications regarding received data communications if the context is conducive for rendering and/or hold notifications until the context becomes conducive for rendering.

In an aspect, in response to reception of a data communication by the phone, a context component executed by the phone and/or the onboard computer system of the vehicle determines the driving context of the vehicle. In another aspect, the context component can continuously determine and monitor the driving context of the vehicle. For example, the context component can determine the driving context of the vehicle based information regarding motion and speed of the vehicle, driving operations of the vehicle (e.g., acceleration, deceleration, breaking, activation/deactivation of cruise control, etc.), analysis of image data captured of the external environment of the vehicle, routing/navigation information, known or inferred driving patterns of the driver, current traffic conditions associated with the current location of the vehicle, and the like. In some embodiments, the context component can employ AI and/or machine learning techniques to facilitate determining the context of the vehicle. For example, in association with detecting the vehicle being stopped (or about to become stopped), the context component can predict how long the vehicle will be stopped using AI techniques and/or other techniques. For example, if at a redlight, the context component can determine that the vehicle will be stopped for at least a minimum duration (e.g., one minute or another minimum duration) based on traffic, and a known or inferred duration of the redlight, routing/navigation information, known or inferred driving patterns of the driver, and the like.

A rendering control component, executed by the phone and/or the onboard computer system of the vehicle, further controls the rendering of notification data regarding the data communication via the phone, and/or a display/speaker (or another suitable output device) integrated on or within the vehicle, based on whether the driving context corresponds to an acceptable context for rendering the notification data. If so, the rendering control component renders the notification data, and if not, the rendering control component prevents the rendering of the notification data until the driving context changes and becomes conducive for rendering the notification data.

In an aspect, the user can set up different acceptable contextual criteria for controlling notifications for different data communication received from different entities. For example, in some implementations, notifications for data communications received from certain entities (e.g., predefined entities, emergency contacts, etc.) can be rendered regardless of the driving context. In another example, the user can set up different priority levels for one or more phone numbers in their contact list or any number not in the contact list. If the user has set up priority levels, in some implementations, held messages or notifications can be reordered and rendered according to priority level when the driving context of the vehicle is conducive.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It will be understood that when an element is referred to as being “coupled” to another element (and/or “connected” to another element or variations thereof), it can describe one or more different types of coupling including, but not limited to, chemical coupling, communicative coupling, capacitive coupling, electrical coupling, electromagnetic coupling, inductive coupling, operative coupling, conductive coupling, acoustic coupling, ultrasound coupling, optical coupling, physical coupling, thermal coupling, and/or another type of coupling. As referenced herein, an “entity” can comprise a human, a client, a user, a computing device, a software application, an agent, a machine learning model, an artificial intelligence, and/or another entity. It should be appreciated that such an entity can facilitate implementation of the subject disclosure in accordance with one or more embodiments described herein.

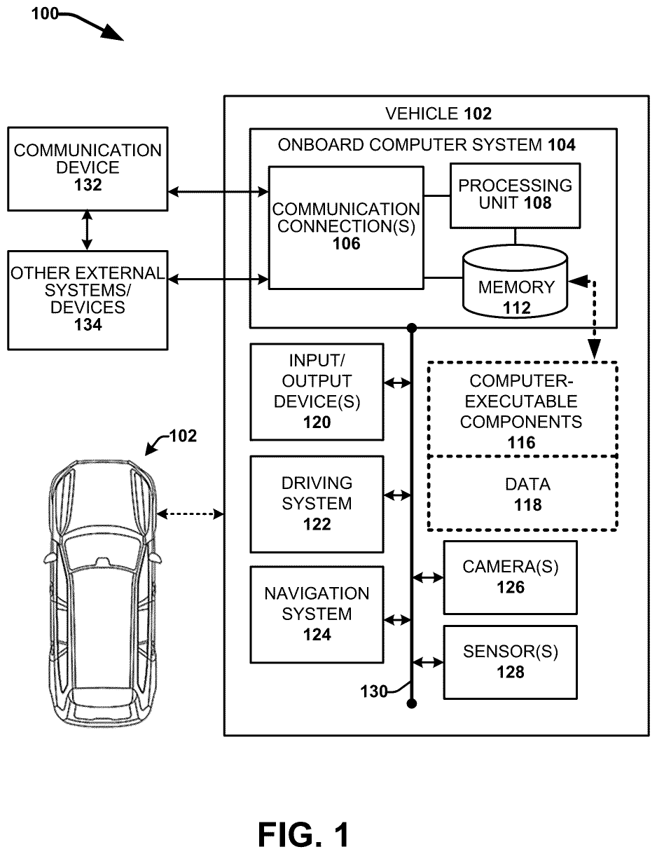

Turning now to the drawings, FIG. 1 illustrates a block diagram of an exemplary system 100 that facilitates controlling phone notifications while driving a vehicle based on different driving contexts, in accordance with one or more embodiments described herein. System 100 comprises vehicle 102, communication device 132 and (optionally) one or more other external systems/devices 134.

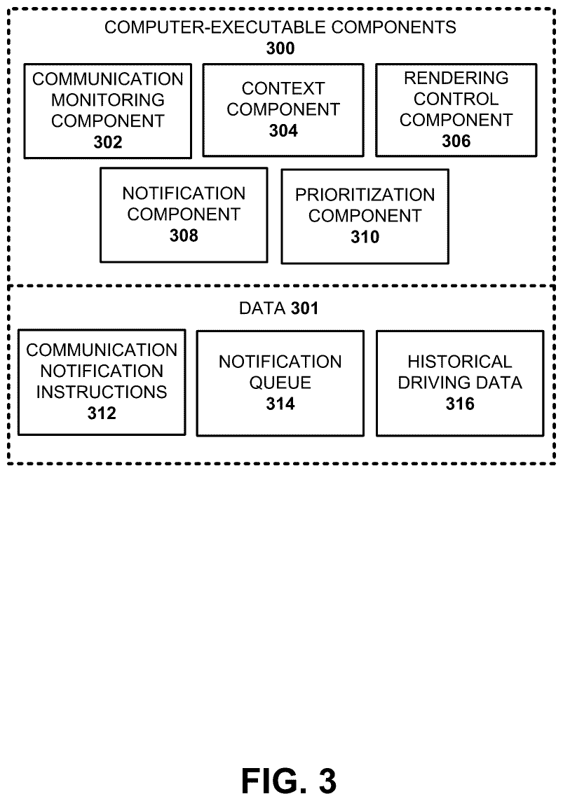

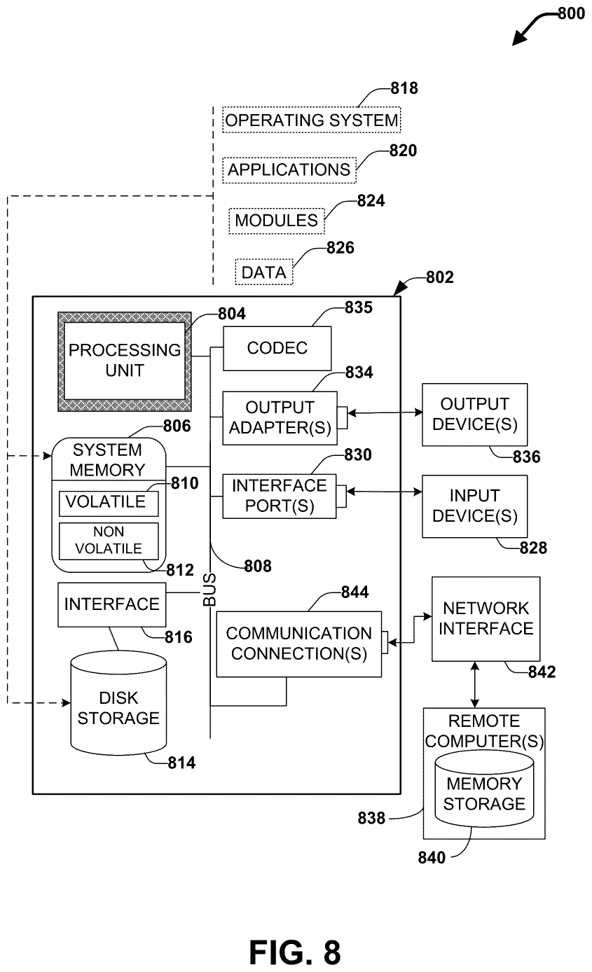

Vehicle 102 can correspond to any type of transportation vehicle. For instance, vehicle 102 can include or correspond to any type of motor vehicle (e.g., a car, a truck, a van, a sport utility vehicle (SUV), etc.). In some implementations vehicle 102 can also include or correspond to an aircraft (e.g., an airplane, a helicopter, or the like), a watercraft, or another type of transportation vehicle. Vehicle 102 includes an onboard computer system 104 comprising a memory 112 that can store computer-executable components 116 and data 118 that facilitate controlling rendering notifications regarding data communications received by communication device 132 in association with operation of vehicle. The onboard computer system 104 includes at least one processor or processing unit 108 that executes the computer-executable component 116 stored in memory 112 to carry out the operations/functions described with respect to the corresponding computer-executable components. Additional details regarding the computer-executable components 116 and data 118 are described infra with reference to FIG. 3. Examples of said memory 112, processing unit 108, and other computer system components that can be included in the onboard computer system 104 to facilitate the various features and functionalities of system 100 can be found with reference to FIG. 8 (e.g., system memory 810, processing unit 804, and the like).

The onboard computer system 104 can also include communication connections 106. Communication connections 106 refers to the hardware and software employed to connect the onboard computer system 104 to communication device 132 and optionally other external systems/devices 134. Any suitable wired and/or wireless technology can be utilized by the communication connections 106 to enable communication of information between the onboard computer system 104 and the communication device 132 and/or the other external systems/devices 134. Suitable technologies include BLUETOOTH®, cellular technology (e.g., 3G, 4G, 5G), internet technology, ethernet technology, ultra-wideband (UWB), DECAWAVE®, IEEE 802.15.4a standard-based technology, Wi-Fi technology, Radio Frequency Identification (RFID), Near Field Communication (NFC) radio technology, and the like.

Vehicle 102 can comprise various electrical and electromechanical systems and devices that are coupled to the onboard computer system 104 via a system bus 130 (and/or via any suitable wired or wireless communication technology), including but not limited to, one or more input/output devices 120, driving system 122, navigation system 124, one or more cameras 126 and one or more sensors 128. The input/output devices 120 can include any suitable input device that provides for receiving user input in association with utilizing the various features and functionalities of the vehicle 102 and any suitable output device that provides for rendering information to users. For example, the input/output devices 120 can include any suitable electronic output device such as a display, a speaker, etc. and any suitable electronic input device, such as a touchscreen display, a microphone, a keypad, a keyboard, a camera, and the like. Examples of suitable input and output devices are further provided with reference to FIG. 8.

Driving system 122 corresponds to the vehicle components responsible for enabling and controlling driving operations of the vehicle. For example, the driving system 122 can include the engine, the transmission, the drivetrain, the steering system, the breaking system, and so on.

Navigation system 124 corresponds to an onboard navigation system of the vehicle. For example, in some implementations, navigation system 124 can include or correspond to a globally positioning system (GPS) based navigation system that provides turn-by-based navigation instructions, routing instructions, and location-based services and mapping applications, to a driver of the vehicle via one or more output devices (e.g., of the input/output device 120) in association with connection to corresponding external system/devices 134 employed by the navigation system 124.

Additionally, or alternatively, navigation system 124 can include or correspond to autonomous or semi-autonomous navigation system of the vehicle 102 that facilitates automatically and/or semi-automatically driving of the vehicle 102. To this end, in one or more embodiments, vehicle 102 can include or correspond to an autonomous vehicle or a semi-autonomous vehicle. An autonomous vehicle, also known as a self-driving car or driverless car, is a vehicle capable of navigating and operating without direct human input using a combination of sensors, cameras, radar, lidar, GPS, and advanced software algorithms to perceive their environment, make decisions, and control their movement. The Society of Automotive Engineers (SAE) has defined six levels of automation for vehicles, ranging from Level 0 (no automation) to Level 5 (full automation). Level 5 autonomy refers to vehicles that can operate in all conditions without any human intervention, while lower levels of autonomy require varying degrees of human input or supervision. In this regard, in some embodiments, vehicle 102 can operate in different modes including an autonomous driving mode (e.g., corresponding to Level 5), a no automation mode (e.g., corresponding to Level 0), and a semi-autonomous driving mode (e.g., corresponding to any level between Level 0 and Level 5).

In some embodiments, the one or more cameras 126 and the one or more sensors 128 can include or correspond to cameras/sensors employed by the navigation system 124 to enable autonomous and/or semi-autonomous navigation. Additionally, or alternatively the one more cameras 126 and/or the one or more sensors 128 can be disassociated with the navigation system. In this regard, the one or more cameras 126 can include one or more cameras located on or within the vehicle that can capture image data (e.g., still images and/or video) of the external environment of the vehicle 102 that can be used to assess the driving context of the vehicle (e.g., as discussed in greater detail below). The one or more sensors 128 can include various types of sensors that can capture sensory information that can be used to facilitate determining the driving context of the vehicle. For example, the one or more sensors 128 can include laser sensors, Light Detection and Ranging (LiDAR) sensors, sonar sensors, audiovisual sensors, perception sensors, motion detectors, proximity sensory, velocity sensors, and the like. Additional examples of the one or more sensors 128 can include (but are not limited to) distance sensors, seats, seat position sensor(s), collision sensor(s), odometers, altimeters, speedometers, accelerometers, vibration meters, moisture sensors, thermometers, seatbelt sensors, wheel speed sensors, a combination thereof, and/or the like.

Communication device 132 can correspond to any type of communication device that can be located on or within vehicle 102 in association with operation of the vehicle 102. For example, communication device 132 can correspond to a phone (e.g., a mobile phone, a smartphone, a smartwatch or another type of wearable communication device, etc.) of a driver of the vehicle 102 or another type of mobile communication device 132 associated with the driver of the vehicle. In other embodiments, communication device 132 can correspond to an onboard communication device that is integrated on or within the vehicle (e.g., a dedicated communication device that is physically coupled to the vehicle and configured to remain attached to the vehicle).

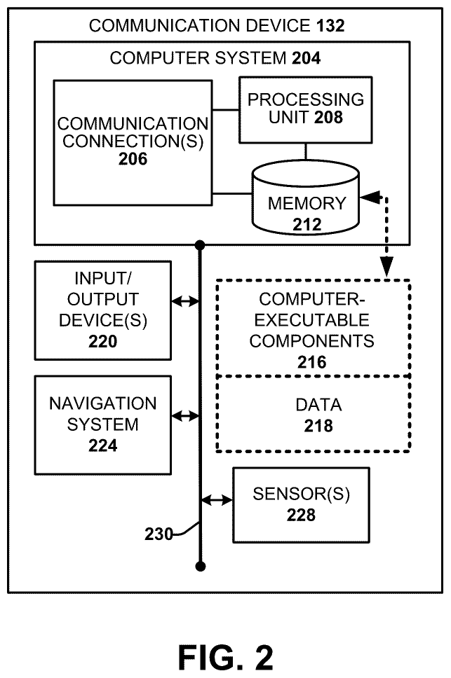

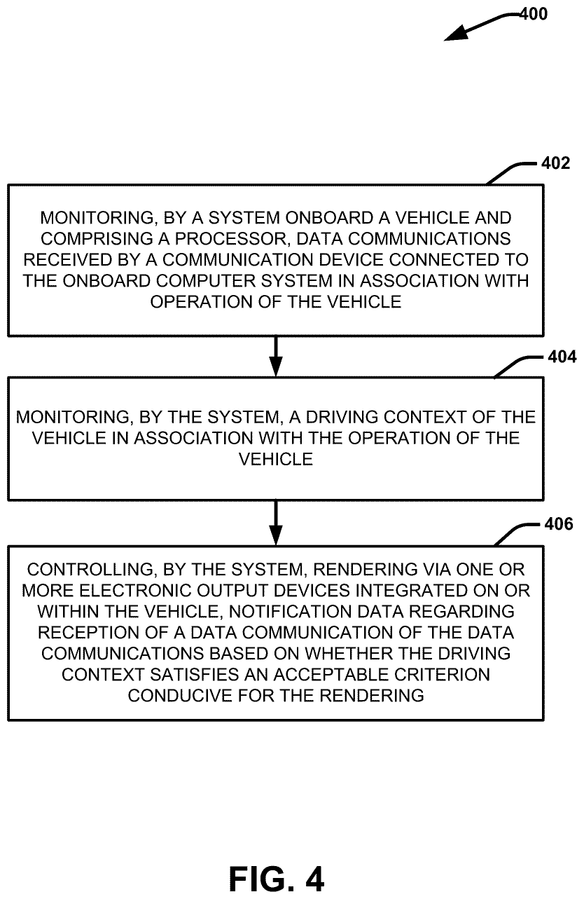

In this regard, FIG. 2 illustrates a block diagram of communication device 132 in accordance with one or more embodiments described herein. With reference to FIGS. 1 and 2, communication device 132 can include a computer system 204 that can include same or similar elements as computer system 104. In this regard, computer system 204 can comprise a memory 212 that can store computer-executable components 216 and data 218 that facilitate controlling rendering notifications regarding data communications received by communication device 132 in association with operation of vehicle 102. The onboard computer system 2104 includes at least one processor or processing unit 208 that executes the computer-executable component 216 stored in memory 212 to carry out the operations/functions described with respect to the corresponding computer-executable components. Additional details regarding the computer-executable components 216 and data 218 are described infra with reference to FIGS. 3 and 4. Examples of said memory 212, processing unit 208, and other computer system components that can be included in computer system 104 to facilitate the various features and functionalities of system 100 can be found with reference to FIG. 8 (e.g., system memory 810, processing unit 804, and the like).

Communication device 132 can include communication connections 206. Communication connections 206 refers to the hardware and software employed to connect the communication device 132 to other external systems/device 134 in association with performing data communications. For example, the other external systems/devices 134 can include or correspond to other communication devices (e.g., other phones), and/or any other type of system or device configured to communicate information using any suitable wireless technology (e.g., servers, application servers, remote computers, Internet of Things (IoT) devices, other vehicles, etc.). In this regard, any suitable wireless technology can be utilized by the communication connections 206 to enable communication of information between the communication device 123 and other external systems/device 134. Suitable technologies include BLUETOOTH®, cellular technology (e.g., 3G, 4G, 5G), internet technology, ethernet technology, ultra-wideband (UWB), DECAWAVE®, IEEE 802.15.4a standard-based technology, Wi-Fi technology, Radio Frequency Identification (RFID), Near Field Communication (NFC) radio technology, and the like. Communication connections 206 can also include hardware and software employable to connect the communication device 104 to the vehicle 102 (or more particularly, the computer system 204 to onboard computer system 104). To this end, any suitable wired and/or wireless communication technology can be employed to connect the communication device 132 to the onboard computer system 104.

The input/output devices 220 can include any suitable input device that provides for receiving user input in association with utilizing the various features and functionalities of the communication device 132 and any suitable output device that provides for rendering information to users. For example, the input/output devices 120 can include any suitable electronic output device such as a display, a speaker, etc. and any suitable electronic input device, such as a touchscreen display, a microphone, a keypad, a keyboard, a camera, and the like. Examples of suitable input and output devices are further provided with reference to FIG. 8.

Navigation system 224 can include or correspond to a GPS based navigation system (or the like) employed by the communication device 132. For example, navigation system 224 can include location detection technology (e.g., GPS-based and/or other types of location detection technology) that provides for determining and tracking the location of the communication device 132. Navigation system 224 can also include or correspond to a navigation application executed by the computer system 204 that provides turn-by-based navigation instructions, routing instructions, and location-based services and mapping applications, to user of the communication device (e.g., a driver of the vehicle 102). Communication device can also include on or more sensors 228 that capture sensory information that can facilitate determining the driving context of the vehicle 102 in association with the communication device 132 being located within the vehicle 102 in association with operation of the vehicle by the driver 102. For example, the one or more sensors 228 can include various types of motion sensors that can be used to detect motion and speed of the communication device 132 and thus the corresponding motion and speed of the vehicle 102. Communication device 132 can further include a system bus 230 that couples the computer system 204, the input/output devices 220, the navigation system 224 and the one or more sensors 228 to one another.

FIG. 3 illustrates a block diagram of example computer-executable components 300 and data 301 that facilitate controlling phone notifications while driving vehicle 102 based on different driving contexts, in accordance with one or more embodiments described herein. With reference to FIGS. 1-3, in some embodiments, computer-executable components 300 and data 301 can correspond to computer-executable components 116 and data 118, respectively. In other embodiments, computer-executable components 300 and data 301 can correspond to computer-executable components 216 and data 218, respectively. Still in other embodiments, one or more of the computer-executable components 300 and data 301 can be distributed between the vehicle 102 and the communication device 132. In this regard, one or more of the computer-executable components 300 can correspond to computer-executable components 116 and/or computer-executable components 216, and data 301 can correspond to data 118 and/or data 218.

To this end, in some embodiments, the operations of the computer-executable components 300 can be executed entirely by the vehicle 102 (or more particularly onboard computer system 104) in association with the communication device 132 being connected to the onboard computer system 104 (e.g., via any suitable wired or wireless communication technology). In other embodiments, the operations of the computer-executable components 300 can be executed entirely by the communication device 132 (or more particularly computer system 204) in association with the location of the communication device 132 being on or within the vehicle 102. With these embodiments, the communication device 132 may be connected to the onboard computer system 104 or disconnected form the onboard computer system. Still in other embodiments, the operations of some (e.g., one or more) of the computer-executable components 300 can be executed by the communication device 132 and others (e.g., one or more) of the computer executable components can be executed by the vehicle 102. Regardless of the deployment configuration, the operations of the computer executable components 300 are the same or substantially the same with any variations between the operations of the respective computer-executable components 300 in accordance with these different deployment configurations noted below.

In this regard, the computer-executable components 300 can include (but are not limited to), communication monitoring component 302, context component 304, rendering control component 306, notification component 308 and prioritization component 310. Data 301 can include communications notification instructions 312 and notification que 314, and historical driving data 316.

The communication monitoring 302 can monitor data communications received by communication device 132 in association with operation of the vehicle 102 and location of the communication device 132 on or within the vehicle 102. Reference to “operation of the vehicle 102” refers to the vehicle 102 being driven or otherwise operated by a driver and/or the navigation system 124 in accordance with semi-autonomous and/or autonomous navigation operating modes. For example, operation of vehicle 102 can refer to the vehicle being driven or otherwise moving, as well as being in park, idle, stopped, or other operating scenarios in which the vehicle engine is activated (or otherwise turned on). To this end, the disclosed techniques are concerned with minimizing distractions associated with usage of a phone (e.g., communication device 132) by the driver of the vehicle 102 while driving the vehicle. Thus, the disclosed techniques are particularly directed to scenarios in which the communication device 132 corresponds to a communication device of the driver (e.g., the driver's personal mobile phone, smartphone, or the like) of the vehicle 102 in association with the driver operating (or partially operating) the vehicle.

In this regard, the operations of the computer-executable components 300 provide a conditional driving mode feature for the communication device 132 that controls notifying the driver of the vehicle 102 regarding data communications received by the communication device 132 based on whether the driving context of the vehicle corresponds to an acceptable context conducive for rendering, such as a context wherein the driver can safely and temporarily use their communication device 132 while operating the vehicle. In some embodiments, the features and functionalities of the computer-executable components 300 can be automatically activated (by the communication device 132 and/or the onboard computer system 104) in response to connection of the communication device 132 to the onboard computer system 104 of the vehicle 102. In other embodiments, the features and functionalities of the computer-executable components 300 can be automatically activated by the communication device 132 in response to detection of the communication device 132 being located within the vehicle 102. Still in other embodiments, the features and functionalities of the computer-executable components 300 can be activated by the communication device 132 and/or the onboard computer system 104 in response to reception of user input at the communication device 132 and/or the onboard component system 104 from the driver requesting activation.

The data communications monitored by the communication monitoring component 302 can vary. For example, the data communications can include received voice calls, received video calls, and received text messages. The data communications can also include mobile application notifications; that is, notification messages received by the communication device 132 from application servers of respective mobile applications on the communication device 132 regarding an event, update or activity related to the respective mobile applications. In some embodiments, the communication monitoring component 302 can also monitor any type of notification message generated by the communication device 132 (as opposed to notification messages received by the communication device 132 from another device/system via a communication network).

The context component 306 determines and monitors a driving context of the vehicle 102 in association with the operation of the vehicle, and the rendering control component 310 controls rendering, via one or more electronic output devices located on or within the vehicle 102, notification data regarding reception of a data communication of the data communications based on whether the driving context satisfies an acceptable criterion conducive for the rendering. In some embodiments in which the communication device 132 is connected to the onboard computer system 104 of the vehicle, the one or more electronic output devices can include or correspond to one or more electronic output devices of the vehicle (e.g., included amongst input/output devices 120), such as a center console display, a speaker of the vehicle, or the like. In other words, when the communication device 132 is connected to the onboard computer system 104, the rendering control component 306 can control rendering of notification data regarding data communications received by the communication device 132 via a display, speaker or the like, of the vehicle 102. With these embodiments, the rendering control component 306 may be executed by the communication device 132 or the onboard computer system 104. In other embodiments in which the deployment scenario involves the computer-executable components 300 being executed entirely by the communication device 132 and the communication device is disconnected from the onboard computer system 104, the one or more electronic output devices can include any suitable electronic output device of the communication device 132 (e.g., a display, a speaker, a haptic feedback device, or the like).

The term “notification data” is used herein to refer generally to any type of output data regarding a data communication received by the communication device 132 and/or a message generated by the communication device 132. The format of the notification data can also vary. For example, the format of the notification data can include or correspond to graphical data configured for rendering via an electronic display, audio data configured for rendering via a speaker, haptic feedback for rendering via a haptic feedback device, and/or another suitable format. In some embodiments, the notification component 308 can generate the notification data. The notification data can vary depending on the type of the data communication and other factors.

For example, in some implementations, with respect to received text messages, the notification component 308 can generate notification data that indicates a text message was received by the communication device 132. The notification data can also include information regarding the entity from which the text message was received (e.g., the phone number, the name of the entity, or the like) and the type of the text message (e.g., a cellular text message, a particular messaging application, etc.). In some implementations in which the communication device 132 is connected to the onboard computer system 104 (e.g., via a wired connection, BLUETOOTH, or another suitable wireless communication technology), the rendering control component 306 can also control rendering the actual text message via one or more electronic output devices of the vehicle when the context is appropriate. For example, the rendering control component 306 can render the text message via an electronic display located on or near the dashboard of the vehicle or another display accessible to the driver based on the driving context of the vehicle. In another implementation, using text-to-speech technology, the rendering control component 306 can convert the text message to an audible format and render an audible reading of the text message via a speaker of the communication device 132 and/or the vehicle 102 based on the driving context of the vehicle.

In other implementations with respect to received and/or generated mobile application notifications at the communication device 132, the notification component 308 can generate notification data that indicates a notification was received and the particular application associated with the notification. The rendering control component 306 can further control rendering of the notification data via one or more electronic output devices of the communication device 132 and/or the vehicle 102 to inform the user regarding reception of the mobile application notification based on the driving context of the vehicle. In some implementations, the received and/or generated mobile application notification can include or be associated with additional information, such as text regarding the particular event, update or mobile application activity for which the notification is based. In some embodiments, the rendering control component 306 can also control rendering this additional information via one or more electronic output devices of the communication device 132 and/or the vehicle 102 based on the driving context of the vehicle.

In other implementations with respect received voice and/or video calls at the communication device 132, the notification component 308 can generate notification data regarding reception of the call. In accordance with these implementations, the rendering control component 306 can also control blocking received calls or otherwise preventing the communication device 132 and/or the onboard computer system 104 from rendering output data indicating the call is being received at the time of reception thereof. For example, in some embodiments, based on reception of a call by the communication device 132 at time which the driving context is acceptable for answering, the rendering control component 306 can allow the call to be received and optionally answered via the communication device 132 and/or the vehicle 102. For instance, the notification component 308 can generate notification data (e.g., audio notification data, visual notification data, haptic feedback notification data (e.g., a vibration or the like)) indicating that a call is being received (and optionally the entity from which it is being received) and render the notification data via an electronic output device of the vehicle 102 (in implementations in which the communication device 132 is connected to the onboard computer system 104) and/or the communication device 132. In some implementations of these embodiments, based on reception of a call by the communication device 132 at a time when the driving context is not acceptable for answering, the rendering control component 306 can block or silence the call. In addition, the notification component 308 can also generate notification data for the call that indicates the call was received and blocked (or silenced), the time at which the call was received, and the entity from which the call was received. The notification component 308 can further store the notification data in a notification queue 314 (e.g., any suitable type of data storage device associated with the communication device 132 and/or the vehicle 102). The rendering control component 306 can further render some or all of the notification data stored in the notification queue (e.g., via one or more output devices of the communication device 132 and/or the vehicle 102) once the driving context of the vehicle 102 changes and becomes acceptable for rendering.

In this regard, notification data stored in the notification queue 314 can include any type of notification data regarding any type of data communication that was not rendered at the time it was received/generated by the communication device 132 based on the driving context of the vehicle at the time not being conducive for rendering at the time of reception. For example, in response to reception of a text message by the communication device 132 at time when the driving context is considered unacceptable for informing the driver regarding reception of the text message, the notification component 308 can generate notification data regarding the received text message and add it to the notification queue 314. Similarly, in response to reception of a mobile application notification by the communication device 132 at time when the driving context is considered unacceptable for informing the driver regarding reception of the text message, the notification component 308 can generate notification data regarding the received text message and add it to the notification queue 314. The rendering control component 306 can further render some or all of the notification data stored in the notification queue (e.g., via one or more output devices of the communication device 132 and/or the vehicle 102) once the driving context of the vehicle 102 changes and becomes acceptable for rendering.

To this end, the rendering control component 306 controls rendering (via the communication device 132 and/or the vehicle) of notification data regarding data communications received by the communication based on the driving context of the vehicle, including rendering the notification data when the driving context is acceptable and preventing the rendering when the driving context is not acceptable. In some embodiments, the rendering control component 306 can also control the rendering based on the entities from the data communications are received. In some embodiments, the rendering control component 306 can also control the rendering based on other specified criteria related to the driving context and/or the data communication. For example, the other criteria may relate to the timing of the received data communication, the semantic content of the data communication (e.g., as applied to text messages and/or mobile application notifications), a priority level of the data communication, the frequency of past reception of data communications from the same entity, and the like.

To facilitate this end, the communication notifications instructions 312 can define acceptable driving context criteria for rendering the notification data. The acceptable driving context criteria can define one or more driving contexts considered acceptable for rendering notification data regarding received data communications by the communication device 132. The one or more acceptable driving contexts can be defined by one or more contextual criteria. For example, in some implementations, the one or more contextual criteria can include the vehicle being stopped, and/or being stopped for a minimum duration of time, such as being stopped at a redlight for the minimum duration of time, being stopped in traffic for the minimum duration of time, being stopped in a parked position for the minimum duration of time, or the like. In another example, an acceptable driving context can include the vehicle being operated in an autonomous driving mode or a semi-autonomous driving mode. In another example, an acceptable driving context can include the vehicle being driven on a highway with cruise control activated (or otherwise at a steady speed). Yet in another situation, an acceptable context for rendering phone notifications can correspond to the vehicle being driven at a steady speed on the highway with low traffic around and/or the vehicle being operated in a semi-autonomous or full autonomous drive mode and expected to remain in this mode for a minimum duration of time.

In this regard, it should be appreciated that an acceptable driving context for rendering notification data regarding data communications received by the communication device can include various different types of driving contexts associated with low or minimal risk attributed to the driver being distracted by the notification data and/or temporary usage of their communication device 132 while operating the vehicle. To this end, acceptable driving contexts are not limited to the example contexts above and can vary and be based on one or more acceptable criterion. In some embodiments, the acceptable criterion relates to at least one of: a driving mode of the vehicle, the vehicle being stopped, an estimated duration of time over which the vehicle is expected to remain stopped, an amount of traffic around the vehicle, a speed of the vehicle, an estimated measure of variation to the speed of the vehicle, a location of the vehicle, a weather condition, a road condition, a time of day, and/or a day of the week.

In addition, the acceptable criteria can vary for different types of data communications, different entities from which the data communications are received, different priority levels associated with the data communications, and other potential conditional factors. In this regard, in some embodiments, the communication notification instructions 312 can also define different conditional rendering rules for rendering notification data regarding data communications tailored based on different types of the data communications, different entities from which the data communications are received, content of the data communications, priority level associated with the data communications, content of the data communications and other conditions factor. In some implementations, the different notification rendering rules may be user defined. For example, a user may specify one or more specific contacts in their phone that they would like to be notified when receiving any type of data communication therefrom, regardless of driving context. In accordance with this example, the communication notification instructions for these contacts can direct the rendering control component 306 to render notification data in response to reception of any data communications from such contacts under any and all driving contexts (e.g., all driving contexts are considered acceptable). In another example, the communication notification instructions 312 can direct the rendering control component 306 to notify the driver regarding data communications received from emergency responders (or the like) regardless of driving context (e.g., all driving contexts are considered acceptable). In another example, the communication notification instructions 312 can direct the rendering control component 306 to notify the driver regarding reception of phone calls in all driving contexts yet only notify the driver regarding reception of text messages in defined driving contexts considered acceptable (e.g., in accordance with one or more defined acceptable criterion).

In another example, in combination with an acceptable driving context, the rendering control component 306 can be configured (e.g., in accordance with criteria defined in the communication notification instructions 312) to render notification data regarding received text messages and/or mobile application notifications based on the textual content included with the respective messages/notifications. With these embodiments, the communication monitoring component 302 can be configured to classify the semantic nature of the messages based on analysis of the textual content of the messages (e.g., using natural language processing (NLP) and/or other machine learning techniques). For example, in some implementations, based on analysis of the textual terms and phrases included in a received message, the communication monitoring component 302 can assign a priority or urgency level to the respective messages. In some cases, terms indicative of the priority level can be expressly included in the messages (e.g., such a “urgent,” “high priority,” “please respond right away,” etc.). The communication notification instructions 312 can further define the contextual rendering protocol for received messages based on assigned priority level. For example, a user may desire to receive notification for messages classified with a high priority level under any driving context and messages with a low priority level only when the driving context meets certain defined criteria, such as when stopped for a minimum duration of time.

In some embodiments, the prioritization component 310 can prioritize the order of different notifications for different data communications held in the notification queue 314 for rendering at a time when the driving context becomes acceptable for rendering. For example, in various implementations, over a course of operation of the vehicle, the driver may receive a plurality of different data communications. The different data communications can vary based on type (e.g., a phone call, a video call, a text message, a mobile application notification, etc.), the entity associated with the data communication (e.g., the person or phone number from which a call/text message was received, the particular mobile application providing the notification), priority level, content and so on. With these embodiments, the prioritization component 310 can order or re-order the different notifications held in the notification queue 314 in accordance with a priority order determined for the respective data communications based on defined prioritization criteria included in the communication notification instructions 312. When the driving context of the vehicle becomes acceptable for rendering, the rendering control component 306 can further render the notifications in accordance with the priority order.

To facilitate the disclosed techniques, the context component 304 can determine and/or monitor the driving context of the vehicle in association with operation of the vehicle 102. For example, in some embodiments, the context component 304 can continuously determine and monitor the driving context of the vehicle over the course of operation of the vehicle, thus regularly or continuously updating the driving context in real-time over the course of operation of the vehicle. In other embodiments, the context component 304 can be configured to determine the driving context of the vehicle in response to reception of a data communication by the communication device 132. In some implementations of these embodiments, based on a determination (e.g., by the rendering control component 306 and using the communication notification instructions 312) that the driving context of the vehicle at the time of reception of a data communication does not satisfy the acceptable driving context criterion or criteria for rendering notification data to the driver, the notification component 308 can generate and/or add the notification data to the notification queue 314. The context component 304 can further be configured to determine and monitor the driving context of the vehicle in association with detecting whether a change to the driving context results in the driving context satisfying the acceptable criteria following the reception of the data communication. In this regard, based on a determination that a change to the driving context results in the driving context satisfying the acceptable criteria, the rendering control component 306 can be configured to render the notification data held in the notification queue 314 at this time. Thereafter, so long as no notification data is being held in the notification queue, the context component 304 can forgo from determining and monitoring the driving context of the vehicle, that is until another data communication is received by the communication device 132. In this manner, the system executing the context component 304 (e.g., onboard computer system 104 and/or computer system 204) can minimize utilization of resources (e.g., power, battery drain, and computational resources) involved with operations of the context component 304.

To this end, the mechanism or mechanisms via which the context component 304 determines or infers the driving context of the vehicle can vary. Because the disclosed techniques are concerned with detecting when the driving context of the vehicle meets one or more acceptable criteria, the context component 304 can restrict assessment of the driving context of the vehicle to techniques required to detect the acceptable criteria. As noted above, in various embodiments, the acceptable criteria can relate to a driving mode of the vehicle, the vehicle being stopped, an estimated duration of time over which the vehicle is expected to remain stopped, an amount of traffic around the vehicle, a speed of the vehicle, an estimated measure of variation to the speed of the vehicle, a location of the vehicle, a weather condition, a road condition, a time of day, and/or a day of the week.

In various implementations, the context component 304 assess the driving context of the vehicle by interfacing with the driving system 122, the navigation system 124 and/or the navigation system 224, and/or using data captured via one or more cameras 126, one or more sensors 128 and/or one or more sensors 228. For example, in association with interfacing with the driving system 122, the context component 304 can determine information regarding vehicle movement, speed, acceleration, deceleration, breaking, and driving mode (e.g., cruise control mode, autonomous driving mode, semi-autonomous driving mode, highway driving mode, etc.). The context component 304 can also interface with the navigation system 124 and/or navigation system 224 to determine information regarding vehicle location, route, movement, speed, traffic conditions, and the like. The context component 304 can also use image data of the external environment of the vehicle captured via one or more cameras 126 and sensory data captured via one or more sensors 128 in association with determining the context of the vehicle. For example, based on analysis of image data captured via the one or more cameras 126 (e.g., using various image analysis algorithms/techniques, such as object recognition, SLAM, and others), the context component 304 can determine the basis for which the vehicle is stopped, whether the vehicle is about to become stopped (e.g., approaching a red light, approaching a traffic jam, etc.), traffic conditions around the vehicle, road conditions, and the like. The context component 304 can also assess image data and/or sensory data (e.g., Lidar data) in association with assessing traffic conditions around the vehicle, such as the amount of other vehicles around the vehicle and relative positions (distances) between the respective vehicles.

The context component 304 can also access various other external systems/devices 134 (e.g., network accessible systems/devices) providing information regarding weather conditions, road conditions, traffic conditions and the like, associated with the location and route of the vehicle. For example, in some implementations the other external systems/devices can include a system that provides real-time information regarding the current status and timing of road and traffic conditions associated with the location of the vehicle, the route of the vehicle, and the like (e.g., status and timing of traffic lights, drawbridges, blockages, and the like).

In some embodiments, the context component 304 can employ AI and/or various machine learning techniques to facilitate determining or inferring the driving context of the vehicle 102 based on the various sources of input discussed above (e.g., driving system 124, navigation system 124 and/or navigation system 224, cameras 126, sensors 128, sensors 228, and various other external system/device 134). For example, in various embodiments, an acceptable driving context of the vehicle can correspond to the vehicle being stopped for a minimum duration of time. In some implementations of these embodiments, using AI and/or machine learning, the context component 304 can estimate or otherwise predict the duration of time the vehicle will remain stopped in association with detecting the vehicle stopping or becoming stopped. For example, the using AI and/or machine learning, the context component 304 can determine or infer the reason for which the vehicle is stopped. The context component 304 can further predict whether the vehicle will be stopped for the minimum duration of time based on the reason, the route of the vehicle, the location of the vehicle at which the vehicle is topped, a traffic condition associated with the location, and other factors. In some embodiments, the context component 304 can also assess historical driving data 316 for the driver in association with inferring the driving context of the vehicle 102. For example, the historical driving data 316 can include tracked information for the driver of the vehicle regarding usage of the vehicle over time, including past driving routes, driving conditions along the routes and locations, stops, durations of the stops, driving patterns and the like. To this end, using machine learning, the context component 304 can infer a current driving context of the vehicle based on same or similar driving contexts associated with same or similar locations and routes in the past. In this regard, the context component 304 can learn driving and traffic patterns associated with various routes and locations over time, and thus learn expected driving contexts associated with different routes and locations.

To facilitate this end, the context component 304 can employ various types of machine learning techniques for learning explicitly or implicitly. Inferring or learning can employ a probabilistic or statistical-based analysis to infer an action that is to be executed. For example, in some implementations, a support vector machine (SVM) classifier can be employed. Other learning approaches that can be employed by the context component 304 can include usage of neural networks (e.g., including deep neural networks, deep adversarial neural networks, convolutional neural networks, and the like), Bayesian networks, decision trees, a nearest neighbor algorithms, boosting algorithm, gradient boosting algorithms, linear regression algorithms, k-means clustering algorithms, association rules algorithms, q-learning algorithms, temporal difference algorithm, and probabilistic classification models providing different patterns of independence can be employed. Learning as used herein also is inclusive of statistical regression that is utilized to develop models of priority.

As will be readily appreciated from the subject specification, the subject innovation can employ learning classifiers that are explicitly trained (e.g., via a generic training data) as well as implicitly trained (e.g., via observing user behavior, receiving extrinsic information) so that the learning classifier is used to automatically determine according to predetermined criteria which action to take. For example, SVM's can be configured via a learning or training phase within a learning classifier constructor and feature selection module. A learning classifier is a function that maps an input attribute vector, k=(k1, k2, k3, k4, kn), to a confidence that the input belongs to a learning class—that is, f(k)=confidence(class).

FIG. 4 illustrates a block flow diagram of an example, non-limiting computer-implemented method 400 for controlling phone notifications while driving a vehicle based on different driving contexts, in accordance with one or more embodiments described herein. Method 400 comprises, at 402, monitoring (e.g., via communication monitoring component 302), by a system onboard a vehicle and comprising a processor (e.g., onboard computer system 104), data communication received by a communication device (e.g., communication device 132) connected to the onboard computer system in association with operation of the vehicle. At 404, method 400 comprises monitoring, by the system a driving context of the vehicle in association with the operation of the vehicle (e.g., via context component 304). At 406, method 400 comprises controlling, by the system (e.g., via rendering control component 306), rendering via one or more electronic output devices integrated on or within the vehicle, notification data regarding reception of a data communication of the data communications based on whether the driving context satisfies an acceptable criterion conducive for the rendering.

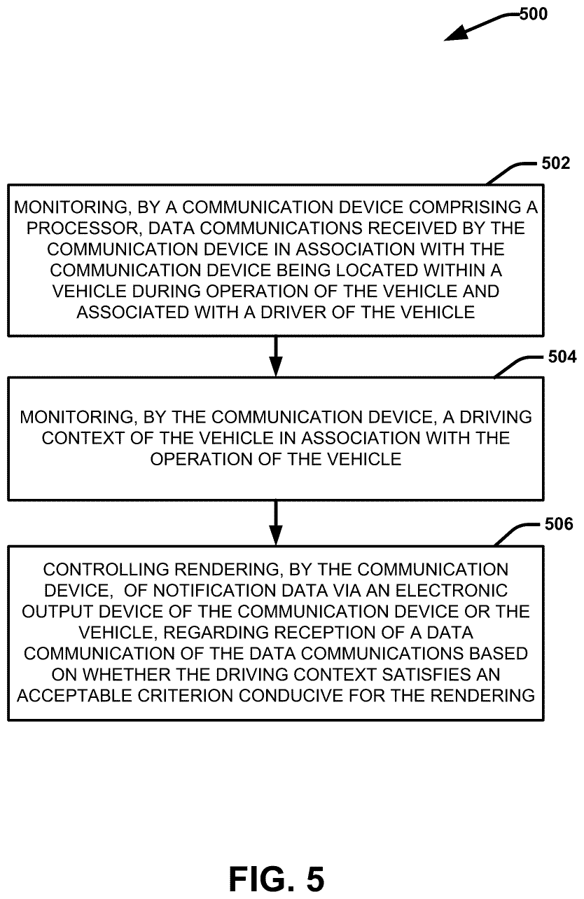

FIG. 5 illustrates a block flow diagram of an example, non-limiting computer-implemented method 500 for controlling phone notifications while driving a vehicle based on different driving contexts, in accordance with one or more embodiments described herein. Method 500 comprises, at 502, monitoring (e.g., via communication monitoring component 302), by a communication device comprising a processor (e.g., communication device 132), data communication received by the communication device in association with the communication device being located within a vehicle during operation of the vehicle and associated with a driver of the vehicle connected to the onboard computer system in association with operation of the vehicle. At 504, method 500 comprises monitoring, by the communication device, a driving context of the vehicle in association with the operation of the vehicle (e.g., via context component 304). At 506, method 500 comprises controlling rendering, by the communication device (e.g., via rendering control component 306), of notification data via an electronic output device of the communication device or the vehicle, regarding reception of a data communication of the data communications based on whether the driving context satisfies an acceptable criterion conducive for the rendering.

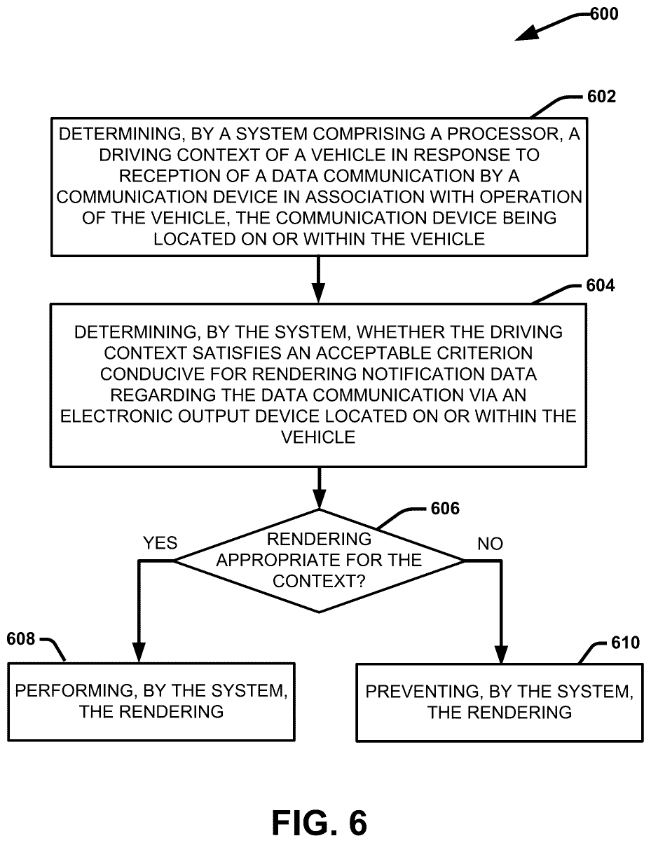

FIG. 6 illustrates a block flow diagram of an example, non-limiting computer-implemented method 600 for controlling phone notifications while driving a vehicle based on different driving contexts, in accordance with one or more embodiments described herein. Method 600 comprises, at 602, determining (e.g., via context component 304), by a system comprising a processor (e.g., onboard computer system 104 and/or computer system 204), a driving context of a vehicle in response to reception of a data communication by a communication device in association with operation of the vehicle, the communication device being located on or within the vehicle. At 604, method 600 comprises determining, by the system (e.g., via rendering control component 306), whether the driving context satisfies an acceptable criterion conducive for rendering notification data regarding the data communication via an electronic output device located on or within the vehicle. To this end, if at 606, the rendering is determined appropriate for the context, then process 600 proceeds to 608, wherein the system performs the rendering. However, if at 606 the rendering is determined inappropriate for the context, then process 600 proceeds to 610, wherein the system prevents the rendering.

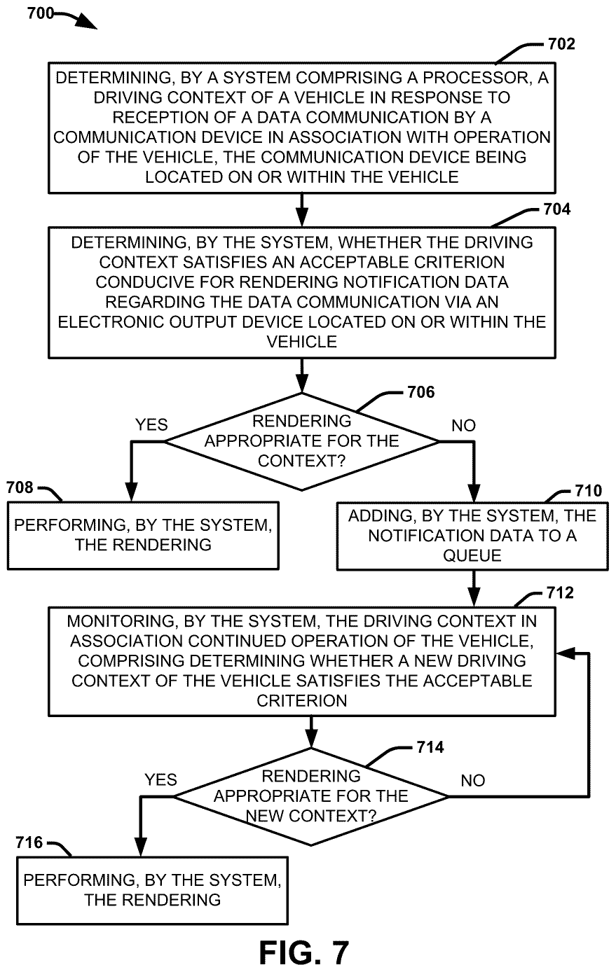

FIG. 7 illustrates a block flow diagram of an example, non-limiting computer-implemented method 700 for controlling phone notifications while driving a vehicle based on different driving contexts, in accordance with one or more embodiments described herein. Method 700 comprises, at 702, determining (e.g., via context component 304), by a system comprising a processor (e.g., onboard computer system 104 and/or computer system 204), a driving context of a vehicle in response to reception of a data communication by a communication device in association with operation of the vehicle, the communication device being located on or within the vehicle. At 704, method 700 comprises determining, by the system (e.g., via rendering control component 306), whether the driving context satisfies an acceptable criterion conducive for rendering notification data regarding the data communication via an electronic output device located on or within the vehicle. To this end, if at 706, the rendering is determined appropriate for the context, then process 700 proceeds to 708, wherein the system performs the rendering.

However, if at 706 the rendering is determined inappropriate for the context, then process 700 proceeds to 710, wherein the system adds the notification data to a queue. At 712, method 700 further comprises monitoring, by the system, the driving context in association with continued operation of the vehicle, comprising determining whether a new driving context of the vehicle satisfies the acceptable criterion. To this end, if at 714, the rendering is determined appropriate for the new driving context, then process 700 proceeds to 716, wherein the system performs the rendering. Otherwise, the system continues to monitor the driving context at 712 until the driving context changes and either satisfies the acceptable criterion or the driving operation of the vehicle is ended (e.g., meaning the vehicle is turned off).

One or more embodiments can be a system, a method, and/or a computer program product at any possible technical detail level of integration. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. To this end, a computer readable storage medium, a machine-readable storage medium, or the like as used herein can include a non-transitory computer readable storage medium, a non-transitory machine-readable storage medium, and the like.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It can be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In connection with FIG. 8, the systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which can be explicitly illustrated herein.

With reference to FIG. 8, an example environment 800 for implementing various aspects of the claimed subject matter includes a computer 802. The computer 802 includes a processing unit 804, a system memory 806, a codec 835, and a system bus 808. The system bus 808 couples system components including, but not limited to, the system memory 806 to the processing unit 804. The processing unit 804 can be any of various available processors. Dual microprocessors and other multiprocessor architectures also can be employed as the processing unit 804.

The system bus 808 can be any of several types of bus structure(s) including the memory bus or memory controller, a peripheral bus or external bus, or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1384), and Small Computer Systems Interface (SCSI).

The system memory 806 includes volatile memory 810 and non-volatile memory 812, which can employ one or more of the disclosed memory architectures, in various embodiments. The basic input/output system (BIOS), containing the basic routines to transfer information between elements within the computer 802, such as during start-up, is stored in non-volatile memory 812. In addition, according to present innovations, codec 835 can include at least one of an encoder or decoder, wherein the at least one of an encoder or decoder can consist of hardware, software, or a combination of hardware and software. Although, codec 835 is depicted as a separate component, codec 835 can be contained within non-volatile memory 812. By way of illustration, and not limitation, non-volatile memory 812 can include read only memory (ROM), programmable ROM (PROM), electrically programmable ROM (EPROM), electrically erasable programmable ROM (EEPROM), Flash memory, 3D Flash memory, or resistive memory such as resistive random access memory (RRAM). Non-volatile memory 812 can employ one or more of the disclosed memory devices, in at least some embodiments. Moreover, non-volatile memory 812 can be computer memory (e.g., physically integrated with computer 802 or a mainboard thereof), or removable memory. Examples of suitable removable memory with which disclosed embodiments can be implemented can include a secure digital (SD) card, a compact Flash (CF) card, a universal serial bus (USB) memory stick, or the like. Volatile memory 810 includes random access memory (RAM), which acts as external cache memory, and can also employ one or more disclosed memory devices in various embodiments. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM) and so forth.

Computer 802 can also include removable/non-removable, volatile/non-volatile computer storage medium. FIG. 8 illustrates, for example, disk storage 814. Disk storage 814 includes, but is not limited to, devices like a magnetic disk drive, solid state disk (SSD), flash memory card, or memory stick. In addition, disk storage 814 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 814 to the system bus 808, a removable or non-removable interface is typically used, such as interface 816. It is appreciated that disk storage 814 can store information related to a user. Such information might be stored at or provided to a server or to an application running on a user device. In one embodiment, the user can be notified (e.g., by way of output device(s) 836) of the types of information that are stored to disk storage 814 or transmitted to the server or application. The user can be provided the opportunity to opt-in or opt-out of having such information collected or shared with the server or application (e.g., by way of input from input device(s) 828).

It is to be appreciated that FIG. 8 describes software that acts as an intermediary between users and the basic computer resources described in the suitable operating environment 800. Such software includes an operating system 810. Operating system 810, which can be stored on disk storage 814, acts to control and allocate resources of the computer 802. Applications 820 take advantage of the management of resources by operating system 810 through program modules 824, and program data 826, such as the boot/shutdown transaction table and the like, stored either in system memory 806 or on disk storage 814. It is to be appreciated that the claimed subject matter can be implemented with various operating systems or combinations of operating systems.

A user enters commands or information into the computer 802 through input device(s) 828. Input devices 828 include, but are not limited to, a pointing device such as a mouse, trackball, stylus, touch pad, touchscreen, keyboard, microphone, joystick, game pad, satellite dish, scanner, TV tuner card, digital camera, digital video camera, web camera, and the like. These and other input devices connect to the processing unit 804 through the system bus 808 via interface port(s) 830. Interface port(s) 830 include, for example, a serial port, a parallel port, a game port, and a universal serial bus (USB). Output device(s) 836 use some of the same type of ports as input device(s) 828. Thus, for example, a USB port can be used to provide input to computer 802 and to output information from computer 802 to an output device 836. Output adapter 834 is provided to illustrate that there are some output devices 836 like monitors/displays, speakers, and printers, among other output devices 836, which require special adapters. The output adapters 834 include, by way of illustration and not limitation, video and sound cards that provide a means of connection between the output device 836 and the system bus 808. It should be noted that other devices or systems of devices provide both input and output capabilities such as remote computer(s) 838.

Computer 802 can operate in a networked environment using logical connections to one or more remote computers, such as remote computer(s) 838. The remote computer(s) 838 can be a personal computer, an onboard vehicle computer, a communication device (e.g., a mobile phone, a smartphone, a smartwatch, a wearable device, etc.), a server, a router, a network PC, a workstation, a microprocessor based appliance, a peer device, a smart phone, a tablet, or other network node, and typically includes many of the elements described relative to computer 802. For purposes of brevity, only a memory storage device 840 is illustrated with remote computer(s) 838. Remote computer(s) 838 is logically connected to computer 802 through a network interface 842 and then connected via communication connection(s) 844. Network interface 842 encompasses wire or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 844 refers to the hardware/software employed to connect the network interface 842 to the bus 808. While communication connection 844 is shown for illustrative clarity inside computer 802, it can also be external to computer 802. The hardware/software necessary for connection to the network interface 842 includes, for exemplary purposes only, internal and external technologies such as, modems including regular telephone grade modems, cable modems and DSL modems, ISDN adapters, and wired and wireless Ethernet cards, hubs, and routers.

It is to be noted that aspects or features of this disclosure can be exploited in substantially any wireless telecommunication or radio technology, e.g., Wi-Fi; Bluetooth; Worldwide Interoperability for Microwave Access (WiMAX); Enhanced General Packet Radio Service (Enhanced GPRS); Third Generation Partnership Project (3GPP) Long Term Evolution (LTE); Third Generation Partnership Project 2 (3GPP2) Ultra Mobile Broadband (UMB); 3GPP Universal Mobile Telecommunication System (UMTS); High Speed Packet Access (HSPA); High Speed Downlink Packet Access (HSDPA); High Speed Uplink Packet Access (HSUPA); GSM (Global System for Mobile Communications) EDGE (Enhanced Data Rates for GSM Evolution) Radio Access Network (GERAN); UMTS Terrestrial Radio Access Network (UTRAN); LTE Advanced (LTE-A); etc. Additionally, some or all of the aspects described herein can be exploited in legacy telecommunication technologies, e.g., GSM. In addition, mobile as well non-mobile networks (e.g., the Internet, data service network such as internet protocol television (IPTV), etc.) can exploit aspects or features described herein.

While the subject matter has been described above in the general context of computer-executable instructions of a computer program that runs on a computer and/or computers, those skilled in the art will recognize that this disclosure also can or may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone), microprocessor-based or programmable consumer or industrial electronics, and the like. The illustrated aspects may also be practiced in distributed computing environments where tasks are performed by remote processing devices that are linked through a communications network. However, some, if not all aspects of this disclosure can be practiced on stand-alone computers. In a distributed computing environment, program modules may be located in both local and remote memory storage devices.

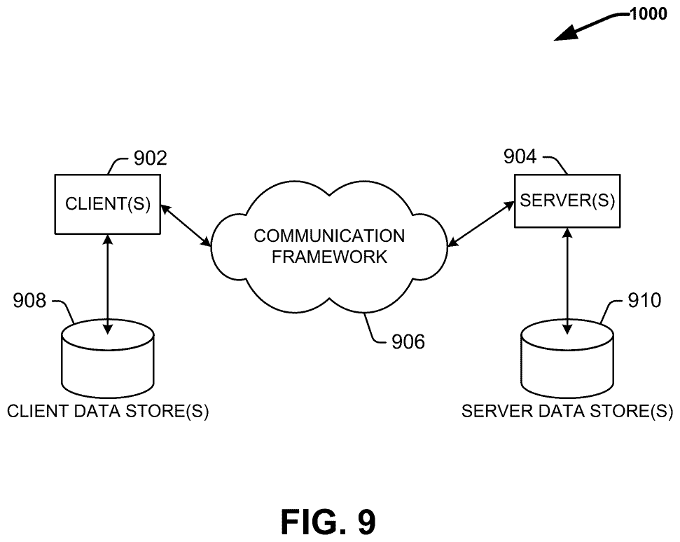

Referring now to FIG. 9, there is illustrated a schematic block diagram of a computing environment 900 in accordance with this specification. The system 900 includes one or more client(s) 902, (e.g., computers, smart phones, tablets, cameras, PDA's). The client(s) 902 can be hardware and/or software (e.g., threads, processes, computing devices). The client(s) 902 can house cookie(s) and/or associated contextual information by employing the specification, for example.

The system 900 also includes one or more server(s) 904. The server(s) 904 can also be hardware or hardware in combination with software (e.g., threads, processes, computing devices). The servers 904 can house threads to perform transformations of media items by employing aspects of this disclosure, for example. One possible communication between a client 902 and a server 904 can be in the form of a data packet adapted to be transmitted between two or more computer processes wherein data packets may include coded analyzed headspaces and/or input. The data packet can include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904. Further, the client(s) 902 can be operatively connected to one or more server data store(s) 910.

In one exemplary implementation, a client 902 can transfer an encoded file, (e.g., encoded media item), to server 904. Server 904 can store the file, decode the file, or transmit the file to another client 902. It is noted that a client 902 can also transfer uncompressed file to a server 904 and server 904 can compress the file and/or transform the file in accordance with this disclosure. Likewise, server 904 can encode information and transmit the information via communication framework 906 to one or more clients 902.

The illustrated aspects of the disclosure can also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art can recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature can be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Further aspects of the invention are provided by the subject matter of the following clauses:
1. A system, comprising:
a communication monitoring component that monitors data communications received by a communication device connected to an onboard computer system of a vehicle in association with operation of the vehicle;
a context component that determines and monitors a driving context of the vehicle in association with the operation of the vehicle; and
a rendering control component that controls rendering, via one or more electronic output devices integrated on or within the vehicle, notification data regarding reception of a data communication of the data communications based on whether the driving context satisfies an acceptable criterion conducive for the rendering.
2. The system of one or more preceding clauses, wherein the rendering control component renders the notification data based on a determination that the driving context satisfies the acceptable criterion.
3. The system of one or more preceding clauses, wherein the rendering control component prevents the rendering of the notification data based on a determination that the driving context fails to satisfy the acceptable criterion.
4. The system of one or more preceding clauses, wherein the rendering control component renders the notification data in response to a change in the driving context resulting in the driving context satisfying the acceptable criterion.
5. The system of one or more preceding clauses, wherein the rendering control component further controls the rendering based on an entity from which the data communication is received, and wherein the acceptable criterion varies for different data communications corresponding to different entities from which the different data communications are received.
6. The system of one or more preceding clauses, wherein the rendering control component further controls the rendering based on a priority level associated with the data communication, and wherein the acceptable criterion varies for different priority levels associated with different data communications.
7. The system of one or more preceding clauses, wherein the data communication comprises a text message and wherein the rendering control component further controls the rendering based on contents of the text message.
8. The system of one or more preceding clauses, wherein the acceptable criterion relates to at least one of: a driving mode of the vehicle, an estimated duration of time over which the vehicle is expected to remain stopped, an amount of traffic around the vehicle, a speed of the vehicle, or an estimated measure of variation to the speed of the vehicle.
9. The system of one or more preceding clauses, wherein the acceptable criterion comprises the driving context corresponding to the vehicle being stopped for a minimum duration of time, and wherein the context component predicts whether the vehicle will be stopped for the minimum duration of time using artificial intelligence.
10. The system of one or more preceding clauses, wherein the context component predicts whether the vehicle will be stopped for the minimum duration of time based on at least one of, a reason for the vehicle being stopped, a route of the vehicle, a location of the vehicle at which the vehicle is stopped, or a traffic condition associated with a location.

The system of clause 1 above with any set of combinations of the vehicles of clauses 2-10 above.
11. A method, comprising:
monitoring, by a system comprising a processor, data communications received by a communication device connected to an onboard computer system of a vehicle in association with operation of the vehicle;
monitoring, by the system, a driving context of the vehicle in association with the operation of the vehicle; and
controlling, by the system, rendering via one or more electronic output devices integrated on or within the vehicle, notification data regarding reception of a data communication of the data communications based on whether the driving context satisfies an acceptable criterion conducive for the rendering.
12. The method of one or more preceding clauses, wherein the controlling comprises performing, by the system, the rendering of the notification data based on a determination that the driving context satisfies the acceptable criterion.
13. The method of one or more preceding clauses, wherein the controlling comprises, preventing, by the system, the rendering of the notification data based on a determination that the driving context fails to satisfy the acceptable criterion.
14. The method of one or more preceding clauses, wherein the controlling comprises performing, by the system, the rendering of the notification data in response to a change in the driving context resulting in the driving context satisfying the acceptable criterion.
15. The method of one or more preceding clauses, wherein the controlling further comprises controlling, by the system, the rendering of the notification data based on an entity from which the data communication is received, and wherein the acceptable criterion varies for different data communications corresponding to different entities from which the different data communications are received.
16. The method of one or more preceding clauses, wherein the acceptable criterion relates to at least one of: a driving mode of the vehicle, an estimated duration of time over which the vehicle is expected to remain stopped, an amount of traffic around the vehicle, a speed of the vehicle, or an estimated measure of variation to the speed of the vehicle.
17. The method of one or more preceding clauses, wherein the acceptable criterion comprises the driving context corresponding to the vehicle being stopped for a minimum duration of time, and wherein the method further comprises predicting, by the system, whether the vehicle will be stopped for the minimum duration of time using artificial intelligence.
18. The method of one or more preceding clauses, wherein the predicting comprises predicting whether the vehicle will be stopped for the minimum duration of time based on at least one of, a reason for the vehicle being stopped, a route of the vehicle, a location of the vehicle at which the vehicle is stopped, or a traffic condition associated with a location.

The method of clause 11 above with any set of combinations of the methods of clauses 12-18 above.
19. A non-transitory machine-readable storage medium, comprising executable instructions that, when executed by a processor, facilitate performance of operations, comprising:
monitoring data communications received by a communication device connected to an onboard computer system of a vehicle in association with operation of the vehicle;
monitoring a driving context of the vehicle in association with the operation of the vehicle; and
controlling rendering via one or more electronic output devices integrated on or within the vehicle, notification data regarding reception of a data communication of the data communications based on whether the driving context satisfies an acceptable criterion conducive for the rendering.
20. The non-transitory machine-readable storage medium of clause 19, wherein the controlling comprises:
performing, by the system, the rendering of the notification data based on a first determination that the driving context satisfies the acceptable criterion; and
preventing, by the system, the rendering of the notification data based on a second determination that the driving context fails to satisfy the acceptable criterion.

What is claimed is:

1. A system, comprising:
a memory that stores computer-executable components; and
a processor that executes the computer-executable components stored in the memory, wherein the computer-executable components comprise:
a communication monitoring component that monitors data communications received by a communication device connected to an onboard computer system of a vehicle in association with operation of the vehicle;
a context component that determines and monitors a driving context of the vehicle in association with the operation of the vehicle; and
a rendering control component that controls rendering, via one or more electronic output devices integrated on or within the vehicle, notification data regarding reception of a data communication of the data communications based on whether the driving context satisfies an acceptable criterion conducive for the rendering.

2. The system of claim 1, wherein the rendering control component renders the notification data based on a determination that the driving context satisfies the acceptable criterion.

3. The system of claim 1, wherein the rendering control component prevents the rendering of the notification data based on a determination that the driving context fails to satisfy the acceptable criterion.

4. The system of claim 3, wherein the rendering control component renders the notification data in response to a change in the driving context resulting in the driving context satisfying the acceptable criterion.

5. The system of claim 1, wherein the rendering control component further controls the rendering based on an entity from which the data communication is received, and wherein the acceptable criterion varies for different data communications corresponding to different entities from which the different data communications are received.

6. The system of claim 1, wherein the rendering control component further controls the rendering based on a priority level associated with the data communication, and wherein the acceptable criterion varies for different priority levels associated with different data communications.

7. The system of claim 1, wherein the data communication comprises a text message and wherein the rendering control component further controls the rendering based on contents of the text message.

8. The system of claim 1, wherein the acceptable criterion relates to at least one of: a driving mode of the vehicle, an estimated duration of time over which the vehicle is expected to remain stopped, an amount of traffic around the vehicle, a speed of the vehicle, or an estimated measure of variation to the speed of the vehicle.

9. The system of claim 1, wherein the acceptable criterion comprises the driving context corresponding to the vehicle being stopped for a minimum duration of time, and wherein the context component predicts whether the vehicle will be stopped for the minimum duration of time using artificial intelligence.

10. The system of claim 9, wherein the context component predicts whether the vehicle will be stopped for the minimum duration of time based on at least one of, a reason for the vehicle being stopped, a route of the vehicle, a location of the vehicle at which the vehicle is stopped, or a traffic condition associated with a location.

11. A method, comprising:
monitoring, by a system comprising a processor, data communications received by a communication device connected to an onboard computer system of a vehicle in association with operation of the vehicle;
monitoring, by the system, a driving context of the vehicle in association with the operation of the vehicle; and
controlling, by the system, rendering via one or more electronic output devices integrated on or within the vehicle, notification data regarding reception of a data communication of the data communications based on whether the driving context satisfies an acceptable criterion conducive for the rendering.

12. The method of claim 11, wherein the controlling comprises performing, by the system, the rendering of the notification data based on a determination that the driving context satisfies the acceptable criterion.

13. The method of claim 11, wherein the controlling comprises, preventing, by the system, the rendering of the notification data based on a determination that the driving context fails to satisfy the acceptable criterion.

14. The method of claim 13, wherein the controlling comprises performing, by the system, the rendering of the notification data in response to a change in the driving context resulting in the driving context satisfying the acceptable criterion.

15. The method of claim 11, wherein the controlling further comprises controlling, by the system, the rendering of the notification data based on an entity from which the data communication is received, and wherein the acceptable criterion varies for different data communications corresponding to different entities from which the different data communications are received.

16. The method of claim 11, wherein the acceptable criterion relates to at least one of: a driving mode of the vehicle, an estimated duration of time over which the vehicle is expected to remain stopped, an amount of traffic around the vehicle, a speed of the vehicle, or an estimated measure of variation to the speed of the vehicle.

17. The method of claim 11, wherein the acceptable criterion comprises the driving context corresponding to the vehicle being stopped for a minimum duration of time, and wherein the method further comprises:
predicting, by the system, whether the vehicle will be stopped for the minimum duration of time using artificial intelligence.

18. The method of claim 17, wherein the predicting comprises predicting whether the vehicle will be stopped for the minimum duration of time based on at least one of, a reason for the vehicle being stopped, a route of the vehicle, a location of the vehicle at which the vehicle is stopped, or a traffic condition associated with a location.

19. A non-transitory machine-readable storage medium, comprising executable instructions that, when executed by a processor, facilitate performance of operations, comprising:
monitoring data communications received by a communication device connected to an onboard computer system of a vehicle in association with operation of the vehicle;
monitoring a driving context of the vehicle in association with the operation of the vehicle; and
controlling rendering via one or more electronic output devices integrated on or within the vehicle, notification data regarding reception of a data communication of the data communications based on whether the driving context satisfies an acceptable criterion conducive for the rendering.

20. The non-transitory machine-readable storage medium of claim 19, wherein the controlling comprises:
performing, by the system, the rendering of the notification data based on a first determination that the driving context satisfies the acceptable criterion; and
preventing, by the system, the rendering of the notification data based on a second determination that the driving context fails to satisfy the acceptable criterion.
